(19) United States
(12) Patent Application Publication
(10) Pub. No.: US 2003/0223848 A1
(43) Pub. Date: Dec. 4, 2003

(54) Sheet material transferring apparatus

(76) Inventor: Alan Clingan, Warsaw, IN (US)

Correspondence Address: RANDALL J. KNUTH P.C., 3510-A STELLHORN ROAD, FORT WAYNE, IN, 46815-4631, US

(21) Appl. No.: 10/160,721

(22) Filed: Jun. 3, 2002

(51) Int. Cl. B62B 1/06

(52) U.S. Cl. 414/444

(57) ABSTRACT

An apparatus for transferring a sheet of material from one location to another. The sheet of material transferring apparatus has a rotatable clamp to allow for the sheet of material to be rotated onto the top surface of a work table.

### BACKGROUND OF THE INVENTION

1. Field of the Invention

The present invention relates to an apparatus utilized to transfer or transport a sheet of material.

2. Description of the Related Art

Transferring a sheet of material, such as wood or metal, can be difficult and awkward. A typical sheet of wood is 4×8, ¾″ thick and weighs approximately 110 lbs. If a single worker attempts to manually transfer or transport the sheet of material, the sheet of material may be dropped and damaged. If the sheet of material is damaged, a new sheet of material will need to purchased which can be very expensive. Furthermore, the worker can become injured while attempting to transfer the sheet of material.

Currently, there are devices that assist in the transferring of a sheet of material. The problem with these transferring devices is that there is no mechanism that allows the sheet of material to be moved conveniently from the transferring device to the top surface of a table. Therefore, the worker would need to lift the sheet of material from the transferring device and place the sheet of material onto the work table so that the worker can work on the sheet of material. As described above, improper lifting or dropping the sheet of material can possibly damage the sheet of material, as well as, possibly injure the worker. The present invention solves the problems of possibly damaging the sheet of material, as well as, possibly injuring the worker lifting the sheet of material.

### SUMMARY OF THE INVENTION

The present invention comprises, in one form thereof, a sheet material transferring apparatus having a shaft and a clamping means that is rotatably connected to the shaft for clamping a sheet of material and rotating the sheet of material into a desired orientation to allow movement of the apparatus and sheet of material about the shop floor. Also, a wheel is connected to the shaft.

The present invention comprises, in another form thereof, a sheet material transferring apparatus having a first shaft and a second shaft wherein the second shaft is connected to the first shaft. Also, a clamping means is rotatably connected to the first shaft for clamping a sheet of material and setting the clamp to various orientations. Two or more wheels are connected to the second shaft.

The present invention, comprises, in yet another form thereof, a sheet material transferring apparatus having an adjustable first shaft perpendicularly connected to a second shaft. Two wheels are connected on opposing ends of the second shaft. A clamp is rotatably connected to the first shaft and a knob is connected to the rotatable clamp for adjusting the rotatable clamp and setting the clamp to various orientations.

An advantage of the present invention is that a worker is able to transfer a sheet of material across a room and place that sheet of material onto a table without any assistance from another worker.

Another advantage of the present invention is that a worker is able to transfer a sheet of material onto the work table without damaging the sheet of material.

A further advantage of the present invention is that a worker is able to transfer a sheet of material onto a work table with less risk of injury to themself.

Yet another advantage of the present invention is that a worker is able to work on the sheet of material, such as with a table saw, without an additional worker to guide the sheet of material into the table saw.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a diagrammatic side view of the sheet transferring apparatus carrying a sheet of material in one form of the present invention;

FIG. 2 is a diagrammatic side view of the sheet transferring apparatus carrying a sheet of material in another form of the present invention;

FIG. 3 is a top view of another form of the present invention; and

FIG. 4 is a front view of yet another form of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

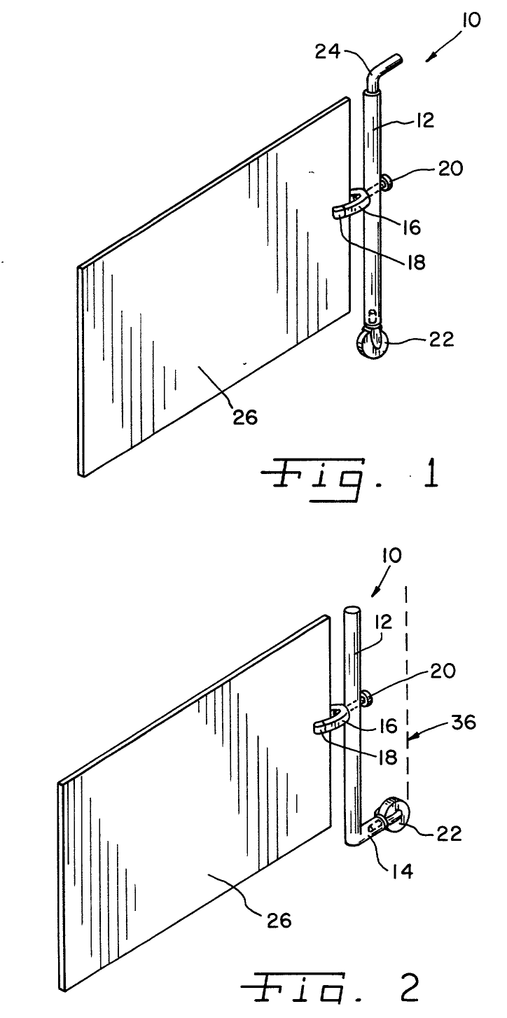

Referring to the drawings and particularly to FIG. 1, there is shown a sheet transferring apparatus 10 of the present invention carrying an item, for example a sheet of material 26. Sheet of material 26 can be formed from wood, metal, glass, plastic or an elastomeric material. The present invention is not limited to these particular materials and other materials can be utilized as well. Furthermore, sheet of material 26 is not limited to the shape as shown in FIG. 1, but can be different sizes and dimensions than that shown in FIG. 1.

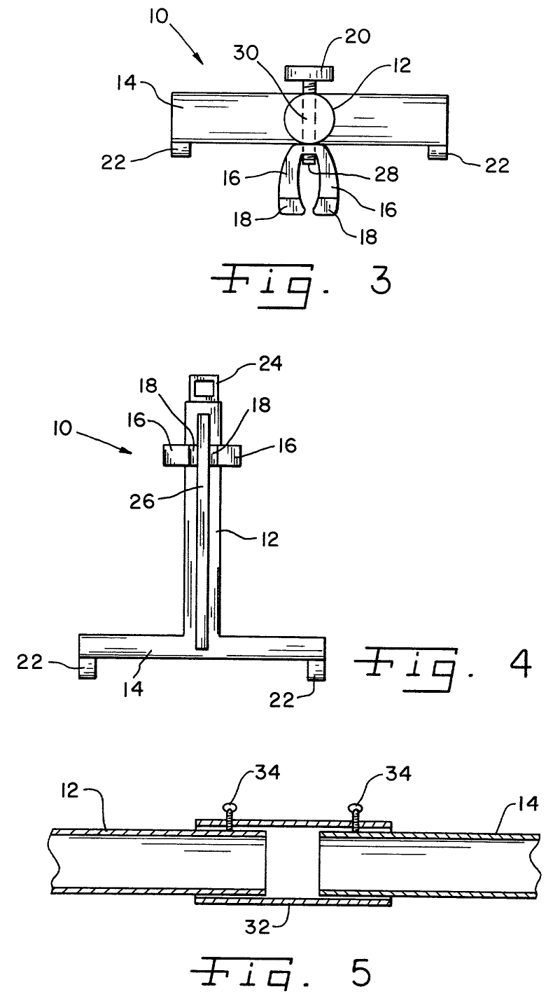

In one embodiment, sheet transferring apparatus 10 has a first shaft 12 and a clamping means 16 rotatably connected to first shaft 12. Clamping means 16 is utilized to clamp sheet of material 26. As shown in FIG. 3, clamping means 16 is U-shaped but can be other shapes, such as square or circular shaped. Clamping means 16 is rotatably connected to first shaft 12 SO that once sheet of material 26 is clamped, sheet of material 26 can be rotated into different positions relative to first shaft 12. Sheet of material 26 can be rotated onto the top surface of a workbench, or rotated to be worked on with a machine, such as a table saw. Sheet of material 26 while gripped in clamping means 16 can be rotated into other positions as well.

First shaft 12 has a small opening (not shown) formed therethrough utilized for mounting clamping means 16. An adjustment knob 20 has a threaded member 30, as shown in FIG. 3, that is inserted into the opening formed in first shaft 12 is attached into the back of clamping means 16. Adjustment knob 20 is rotated in a clockwise direction causing threaded member 30 of knob 20 to travel through the bottom of clamping means 16. Prior to or after threaded member 30 of knob 20 goes through the bottom of clamping means 16, a pad 28 can be connected to the end of threaded member 30. Pad 28 will ensure that sheet of material 26 is not damaged when clamped by clamping means 16. Clamping means 16 can be connected to first shaft 12 in other ways, such as using a fastener to connect clamping means 16 to first shaft 12 that allows clamping means 16 to rotate relative to first shaft 12.

In one form of the present invention, clamping means 16 has spring loaded cams 18 as shown in FIG. 3 and will be described in more detail in the description of the operation of the present invention. If sheet of material 26 is plastic or glass, clamping means 16 can have suction cups on the end of clamping means 16 to securely hold sheet of material 26. Clamping means 16 can also be a vice having jaws wherein a spindle is connected to the vice and the spindle is rotated clockwise to tighten the jaws of clamping means 16 and the spindle is rotated counterclockwise to loosen the jaws of clamping means 16. Other types of clamping means can be utilized as well.

A handle 24, as shown in FIG. 4, can be connected to first shaft 12. Handle 24 can be a part of first shaft 12 with an opening in the center, as shown in FIG. 4, in which a worker can insert their hand into the opening and grip handle 24. Handle 24 can also be a member extending from first shaft 12, as shown in FIG. 1, and a worker can grip the extended member which acts as handle 24.

In one form of the present invention, a wheel 22 is connected to the distal end of first shaft 12, as shown in FIG. 1 using a bolt, fastener or welding. Wheel 22 swivels in relation to the longitudinal axis of first shaft 12 but alternatively, wheel 22 can be stationary in relation to the longitudinal axis of first shaft 12. Other methods of connecting wheel 12 to the distal end of first shaft 12 can be utilized as well.

In another form of the present invention, a second shaft 14 can be connected to first 12, as shown in FIG. 2. Second shaft 14 connects to first shaft 12 using a T-shaped handrail connector (not shown). The T-shaped handrail connector has an opening in the horizontal direction and an opening in the vertical direction. Second shaft 14 is inserted into the horizontal opening and first shaft 12 is inserted into the vertical opening of the T-shaped connector. First shaft 12 and second shaft 14 are held into place within the T-shaped connector using a lock screw connection. First shaft 12 can be moved and screwed into place anywhere along the entire longitudinal axis of the T-shaped connector surrounding the opening allowing for the adjustment of the height of sheet transferring apparatus 10.

Another way to adjust the height of sheet transferring apparatus 10 is to use a straight line connector 32 which can be used to connect first shaft 12 and second shaft 14, as shown in FIG. 5. The straight line connector has a single opening in which one end of each of first shaft 12 and second shaft 14 can be inserted into each side of straight line connector 32. After first shaft 12 and second shaft 14 are inserted into straight line connector 32, tightening screws 34 are used to secure first shaft 12 and second shaft 14 to straight line connector 32. To adjust the height of sheet transferring apparatus 10, either of tightening screws 34 can be loosened and one or more of the shafts can be moved within straight line connector 32 and then tightening screws 34 are used to secure first shaft 12 and second shaft 14 to straight line connector 32.

Also, one end of first shaft 12 can be filleted. The filleted end of first shaft 12 can then be welded to the outer diameter of second shaft 14e.s. FIGS. 2, 3, and 4.

Another means of connecting first shaft 12 and second shaft 14 is to have first shaft 12 larger in diameter than second shaft 14. Holes can be drilled into the outer diameter of first shaft 12 and a screw can be inserted into one of the holes on the exterior of shaft 12 to secure first shaft 12 to second shaft 14. The shafts can then be adjusted in relation to one another based on where first shaft 12 is screwed into contact with the outer diameter of second shaft 14.

In various forms of the invention, as shown in FIGS. 3 and 4, second shaft 14 is connected perpendicular at its appropriate midpoint to first shaft 12. Wheel 22 is connected to each end of second shaft 14 using bolts, fasteners or welding. First shaft 12 can be inserted into an opening in the outer diameter of second shaft 14. In one form of the present invention, one or more of wheels 22 connected to second shaft 14 are co-linear to a line 36 parallel to first shaft 12. An example of at least one of wheels 22 being co-linear to line 36 parallel to first shaft 12 is shown in FIG. 2. Wheels 22 do not need to be co-linear to line 36 and other arrangements of wheels 22 can be utilized as well.

In operation, sheet of material 26 is inserted into clamping means 26 as shown in FIGS. 1, 2 and 4. Knob 20 is turned in a clockwise direction causing threaded member 30 to protrude through the bottom of clamping means 16. Threaded member 30 has pad 28 on the end protruding through the bottom of clamping means 16. As knob 20 continues to be turned clockwise, pad 28 comes into contact with the end of sheet of material 26 that was inserted into clamping means 16. As knob 20 continues to be turned in a clockwise direction, threaded member 30 pushes the end of sheet of material 26 away from clamping means 16. This pushing of sheet of material 26 away from clamping means 16 causes cams 18 to rotate slightly creating a gradually tighter grip onto sheet of material 26. Once a desired grip is applied to sheet of material 26, the worker moves to the end of sheet of material 26 distal to sheet transferring apparatus 10. The worker picks up the end of sheet of material 26 distal to sheet transferring apparatus 10 and pulls clamped sheet of material 26 in the direction of the desired destination for sheet of material 26. Wheels 22 on sheet transferring apparatus 10 allow for ease of transfer of sheet of material 26 to a worktable (not shown) or other desired destination. Once the worker gets clamped sheet of material 26 to the worktable, sheet of material 26 is rotated either by manually grabbing clamped sheet of material 26 and rotating it or by manually rotating clamping means 16 until sheet of material 26 is parallel to the top surface of the worktable. The distance between the top of the worktable and bottom of sheet of material 26 is minimal. Knob 20 is turned in a counterclockwise direction gradually loosening the grip on sheet of material 26. Once threaded member 30 and pad 28 are no longer in contact with sheet of material 26, the worker manually releases one or more of cams 18 and sheet of material 26 can be removed from sheet transferring apparatus 10. Sheet transferring apparatus 10 is then moved away from sheet of material 26 and the worker can begin to operate on sheet of material 26.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A sheet material transferring apparatus comprising:
a shaft;
a clamping means rotatably connected to said shaft for clamping a sheet of material, said clamping means rotatable for rotating a clamped sheet of material relative to said shaft; and
a wheel connected to said shaft.

2. The apparatus of claim 1, wherein said shaft is adjustable.

3. The apparatus of claim 1, wherein said wheel is a swivel wheel.

4. The apparatus of claim 1, further comprising a handle connected to said shaft.

5. The apparatus of claim 1, wherein the sheet of material is made from wood.

6. The apparatus of claim 1, wherein the sheet of material is made from metal.

7. The apparatus of claim 1, further comprising an adjustment means for adjusting said rotatable clamping means.

8. A sheet material transferring apparatus comprising:
a first shaft;
a second shaft connected to said first shaft;
a clamping means rotatably connected to said first shaft for clamping a sheet of material, said clamping means rotatable for rotating a clamped sheet of material relative to said first shaft; and
two or more wheels connected to said second shaft.

9. The apparatus of claim 8, wherein said first shaft is adjustable.

10. The apparatus of claim 8, wherein said second shaft is adjustable.

11. The apparatus of claim 8, wherein said at least one of said two or more wheels are swivel wheels.

12. The apparatus of claim 8, further comprising a handle connected to said first shaft.

13. The apparatus of claim 8, wherein at least one of said two or more wheels are co-linear to a line parallel to said first shaft.

14. The apparatus of claim 8, wherein the sheet of material is made from wood.

15. The apparatus of claim 8, wherein the sheet of material is made from metal.

16. The apparatus of claim 8, further comprising an adjustment means for adjusting said rotatable clamping means.

17. A sheet material transferring apparatus comprising:
an adjustable first shaft perpendicularly connected to a second shaft;
two wheels connected on opposing ends of said second shaft;
a clamping means rotatably connected to said adjustable first shaft for clamping a sheet of material, said clamping means rotatable for rotating a clamped sheet of material relative to said adjustable first shaft; and
a knob connected to said rotatable clamp for adjusting said rotatable clamp.
